(19) United States
(12) Patent Application Publication
(10) Pub. No.: US 2026/0057530 A1
(43) Pub. Date: Feb. 26, 2026

(54) MOTION CAPTURE SYSTEM AND METHOD FOR GENERATING SYNCHRONOUS SCENE IMAGES AND MARKER POSITION DATA

(71) Applicant: NaturalPoint, Inc., Corvallis, OR (US)

(72) Inventors: William F. HAYES, Philomath, OR (US); Colin B. DAVIDSON, Salisbury (GB); Stuart GUARNIERI, Laramie, WY (US); Anthony Louis LAZZARO, Corvallis, OR (US)

(21) Appl. No.: 19/296,766

(22) Filed: Aug. 11, 2025

Related U.S. Application Data
(60) Provisional application No. 63/687,214, filed on Aug. 26, 2024.
(60) Provisional application No. 63/772,373, filed on Mar. 14, 2025.

(51) Int. Cl. G06T 7/246; G06T 11/60; G06V 10/25; H04N 19/172

(52) U.S. Cl. CPC G06T 7/246; G06T 11/60; G06V 10/25; H04N 19/172; G06V 2201/07

(57) ABSTRACT

Motion capture systems and methods involve processing a series frames of digital video image data on-camera to determine the position of markers attached to a moving subject in the scene. Compressed video and corresponding marker position data or object model data are transmitted by each camera while preserving correspondence or synchronization information between each frame of compressed video and the corresponding marker data or object model data. Each frame of the digital image data may be altered on-camera, before compression and transmission, to paint out the markers in the scene before the series of frames of digital image data, so altered, are encoded by a compression algorithm. The encoded and compressed video data and the corresponding marker data sets, or object data based thereon, may be utilized to train machine learning systems or other AI systems for markerless motion capture.

### RELATED APPLICATIONS

This application claims the benefit of priority under 35 U.S.C. § 119 (e) from U.S. Provisional Application No. 63/687,214, filed Aug. 26, 2024, and U.S. Provisional Application No. 63/772,373, filed Mar. 14, 2025, both of which are incorporated herein by reference.

### TECHNICAL FIELD

The present disclosure is directed to motion capture systems and, in particular, to motion capture cameras and methods for collecting digital video data and synchronous position data regarding subjects in a scene, and to related methods of generating high-fidelity training data for machine learning systems for markerless object tracking.

### BACKGROUND

Motion capture systems are used to track the movement of one or more real-world objects to which a computer model may be mapped to produce animation and cinematic special effects that accurately imitate real-world movement. Further, motion capture may allow animation and special effects to be produced more efficiently than frame-by-frame generation techniques. Motion capture systems may also permit an animation director or director of special effects to experiment with different movements or perspectives before mapping the movement to computer models, which may result in more flexible production of content.

Typical motion-capture setups include multiple cameras that detect one or more objects (e.g., people) in a scene, by identifying the position of markers fitted on the objects. The markers may be active markers that emit light, such as a selected wavelength of light, or passive markers like reflectors or white dots that merely reflect incident light, such as infrared illumination generated by an external source. In many cases, the motion-capture cameras are provided with filters to increase the signal-to-noise ratio of the image detected by the cameras in order to more easily identify the markers. Further, a motion-capture setup may include one or more cameras that do not include a filter in order to record a normal view of the scene in the visible spectrum.

U.S. Pat. No. 9,019,349, which is owned by the assignee of the present application, discloses a system of motion capture cameras that include a marker-tracking optical filter that relatively enhances light from markers on a moving object in the scene, and which is selectively interchangeable with a scene-view optical component. The motion capture cameras are remotely controllable so as to selectively transition the motion-capture camera between the marker-tracking mode and a scene mode by switching the marker-tracking optical filter in or out. The remote switching allows the same cameras to capture object position data via the marker-tracking mode and reference scene via the scene mode, but not simultaneously.

The present inventors have recognized the asynchronous capture of scene data and marker data may be suboptimal for certain applications wherein precise correspondence between marker position data and the scene image is paramount.

### SUMMARY

A motion capture system includes one or more motion capture cameras, each having an image sensor that is operable to generate a series of frames of digital image data representing a scene that is visible to the motion capture camera. In some embodiments, the motion capture system may include a set of the motion capture cameras arranged around a capture volume for capturing different aspects of the scene, and the motion capture cameras may be interconnected with each other and/or with a host computer system via a local area network, and collectively synchronized and/or calibrated. Each motion capture camera includes a marker tracking subsystem configured to access the digital image data generated by the image sensor and to process at least a portion of the digital image data to determine, for each of at least some of the frames of the series of frames, a current position of each of a plurality of reflective or light-emitting markers attached to a moving subject in the scene. The marker tracking subsystem, thus, generates a series marker data sets each corresponding to one of a tracked series of the image frames. Each motion capture camera may also include an encoder configured to access the digital image data and to encode at least some of the series of frames as compressed video data, including at least some of the tracked series of frames processed by the marker tracking subsystem. A data communication device of the motion capture camera may be configured to transmit the compressed video data and the series of marker data sets. The frame rate of the motion capture cameras may be between 10 and 1000 frames per second, for example. The tracked series of frames of digital image data may include the entire series of frames, or may consist essentially of one of: a series of frames of digital image data gathered at the frame rate (e.g., a subset of adjacent frames), a series of non-adjacent frames, or a series of adjacent and non-adjacent frames.

Each motion capture camera may further comprise a marker removal subsystem configured to alter each frame of the digital image data to paint out the markers in the scene before the series of frames of digital image data, so altered, are encoded by the encoder. The encoded and compressed video data and the corresponding series of marker data sets may be received by a host computer system of the motion capture system for subsequent use and processing, and may optionally be stored by the host computer system so as to preserve synchronization and/or correspondence between each frame of the compressed video data and its corresponding marker data set, for some or all of the motion capture cameras.

For efficiency and reduced processing burden, the marker tracking subsystem and/or the marker removal subsystem may process only a subset of the digital image data of each frame comprising one or more regions of interest (ROIs) identified to obtain markers. In some embodiments, the series of marker data sets and/or the altered scenes (with markers painted out) may be generated at or about the frame rate of the image sensor and the marker data sets and compressed video data may be transmitted at or about the frame rate. The marker tracking subsystem, the marker removal subsystem and the encoder may all be implemented in a digital data processor, such as one or more field-programmable gate arrays (FPGA) and/or one or more application specific integrated circuits (ASICs) that are each in communication with the image sensor and the communication device. In one embodiment, the image sensor and the digital data processor may be implemented in a single ASIC.

According to a further aspect of the present disclosure, a method of generating motion capture data and image data may comprise the steps of (1) generating, via the image sensor, a series of adjacent and/or non-adjacent frames of digital image data representing a scene that is visible to the motion capture camera; (2) processing at least a portion of the digital image data (such as an ROI) via the marker tracking subsystem to determine, for each of at least some of the frames of the series of frames, a current position of each of a plurality of reflective or light-emitting markers attached to a moving object in the scene, the marker tracking subsystem generating a series of marker data sets, each marker data set corresponding to one of a tracked series of frames of the series of frames and including the current positions of the markers in the scene; (3) encoding at least some of the series of frames of digital image data via the encoder to generate compressed video data, wherein the compressed video data includes at least some of the tracked series of frames processed by the marker tracking subsystem; and (4) via the communication device, transmitting the compressed video data and the series of marker data sets from the motion capture camera. Before the series of frames of digital image data (or portion thereof) is encoded, each frame (or ROI thereof) may be altered by painting out the markers in the scene, thereby generating a frame of altered digital image data for encoding via the encoder.

The compressed, encoded video data and corresponding series of marker data sets generated by systems and methods according to the present disclosure can be utilized to train a machine learning system or other AI system for markerless motion capture. Painting out the markers from the image scenes provides markerless altered video that precisely corresponds to marker data sets on a frame-by-frame basis, enabling accurate object data to be generated regarding the location and orientation of subjects or objects in the markerless scene to help train the machine learning system (e.g., through informing or validating the training). The compressed, encoded video data (with or without painting out the markers) and corresponding marker data sets may also be transmitted to a trained machine learned system. For example, marker data may be used for high precision tracking of some objects or elements in a scene, while markerless AI-based tracking may be used for other elements for which less precision is needed for which it is difficult to attach markers.

Additional aspects and advantages will be apparent from the following detailed description of exemplary embodiments, which proceeds with reference to the accompanying drawings.

### BRIEF DESCRIPTION OF THE DRAWINGS

FIG. 1 illustrates a motion capture system in accordance with one embodiment.

FIG. 2 is a schematic block diagram of networked cameras and host computer system of the motion capture system of FIG. 1.

FIG. 3 illustrates an image of a scene in the normal visible spectrum, including a person with markers attached.

FIG. 4 illustrates marker-tracking data captured from the scene of FIG. 3, showing the position of the markers in the scene.

FIG. 5 illustrates an object model of the person of FIG. 3 including major skeletal joints, which has been constructed from the marker-tracking data of FIG. 4.

FIG. 6 illustrates a method for generating training data for a machine learning system for markerless motion capture, in accordance with one embodiment.

FIG. 7 is an isometric view of one of the cameras of the motion capture system of FIG. 1, in accordance with an embodiment.

FIG. 8 schematically illustrates components of the camera of FIG. 7 in accordance with one embodiment.

### DETAILED DESCRIPTION OF EXEMPLARY EMBODIMENTS

To easily identify the discussion of any particular element or act, the most significant digit or digits in the reference numbers appearing in the drawings and in the following detailed description refer to the figure number being described when the element is first introduced. Identical reference numbers appearing in multiple figures refer to the same element throughout.

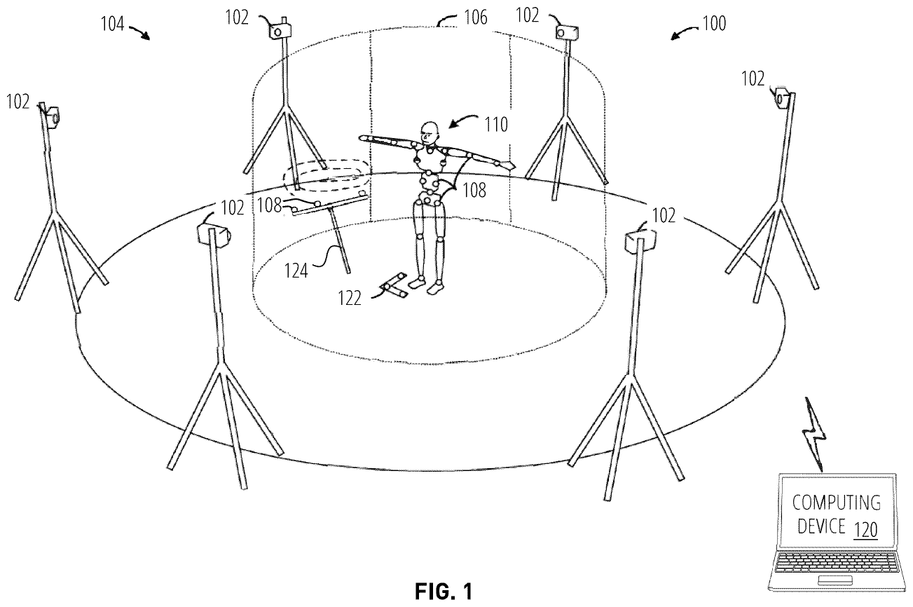

FIG. 1 illustrates an embodiment of a motion capture system 100 according to the present disclosure. Motion capture system 100 includes a plurality of motion capture cameras 102 that are configured to receive light from a scene 104. In the embodiment illustrated, six cameras 102 are distributed around and pointed toward a capture volume 106 so as to capture different aspects of scene 104. In other embodiments, a greater or lesser number of cameras 102 may be used. For example, in some embodiments a single motion capture camera may be used, while other embodiments may utilize between two (2) and one thousand (1000) or more motion capture cameras to capture the scene of a single capture volume from different perspectives.

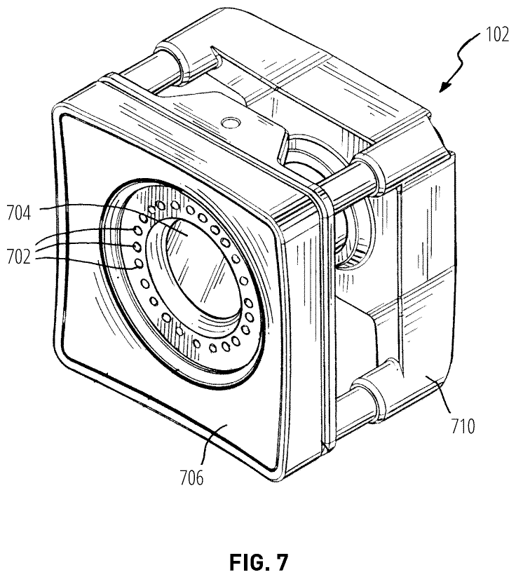

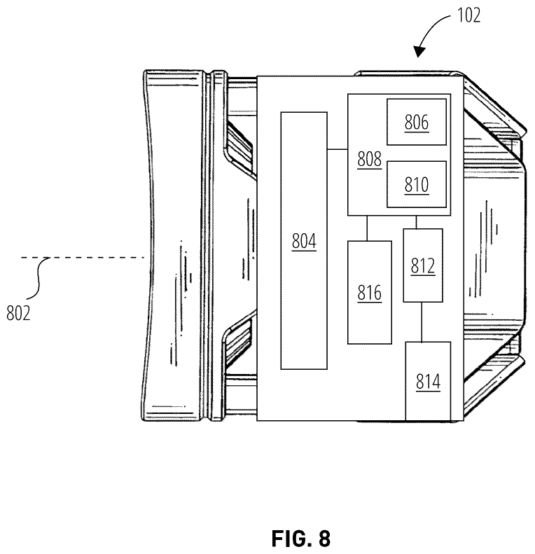

A plurality of markers 108 may be attached to various locations on a subject 110, such as a person or animal, and/or on other objects in the capture volume 106. In some embodiments, markers 108 are passive markers that reflect incident light to enhance the brightness of markers 108 relative to the surrounding scene 104 as detected by the plurality of cameras 102. In other embodiments, markers 108 are active markers that emit their own light, as opposed to merely reflecting light, so that they are brighter than other elements of the subject 110 or the scene 104, making such active markers easily detectable by cameras 102. As an example, each active marker may include one or more light emitting diodes (LED) within a spherical diffusion housing of a predetermined diameter. Passive markers may include various reflective objects or materials, such as white spheres, reflective paint spots, circles or spheres of reflective materials, retro-reflective corner cubes, or retroreflective materials with a plurality of corner cube reflector patterns. The markers can be implemented in any of various shapes and sizes. In some embodiments, cameras 102 may include one or more Illumination sources 702 (FIG. 7) that may omit light substantially along an optical axis 802 (FIG. 8) of the camera 102 to illuminate the scene 104 and markers 108. In some embodiments, the illumination source(s) 702 may emit light that is substantially coaxially aligned with optical axis 802. In some embodiments, the Illumination sources 702 of each camera 102 include LEDs that emit a broad spectrum of visible light and, in some cases, also infrared (IR) illumination. In other embodiments, the Illumination sources 702 are narrowband emitters, such as an IR LED or other IR illumination device that emits wavelengths only in the near IR spectrum. Such IR illumination is reflected by the markers 108 without affecting the visible appearance of the scene 104. In alternative embodiments, various other wavelengths of wideband or narrowband illumination (other than visible or IR) may also be utilized.

The position of markers 108 in the scene 104 may be identified by a marker tracking subsystem of the cameras 102. In some embodiments, this size and shape of the markers may be identified by the marker tracking subsystem, providing additional information about the range (distance from camera) and orientation of the markers. The marker positions and sizes detected by multiple cameras 102 may be correlated, triangulated, and mapped to a three-dimensional (3D) object model to determine the 3D spatial position and movement of the subject 110 or other objects in the capture volume 106. A host computer system 120 may be in communication with cameras 102 and configured to receive marker position data from multiple cameras 102 via a wired or wireless local area network, and to perform marker data correlation, triangulation, and mapping to 3D object models, for recording motion of the subject 110. The subject 110 may include any suitable body or object, or collection of bodies or objects, having movement that is trackable through the use of markers 108 fixed on or relative to the moving bodies or objects. For example, the subject to be tracked may include facial features, animals, people, etc. Moreover, any suitable number of markers may be deployed on an object to suitably track movement of the object. For example, between one and dozens or hundreds of markers may be attached to a single moving subject. In some cases, one or more markers 108 may be attached to an object or other subject that does not move, such as a reference square 122 having three markers defining a plane, which is tracked as a reference datum in the scene 104.

Cameras 102 may also be interconnected to each other via a wired or wireless local area network so that marker data output by one camera 102 may be received by the others to provide marker position feedback. Such marker position feedback may facilitate the operation and fidelity of each camera's marker tracking subsystem, for example. Motion capture system 100 may be set up so that each of the plurality of cameras 102 has a different location and orientation relative to the capture volume 106 to capture the scene 104 from different vantage points, so that marker data from multiple cameras can be used to accurately triangulate the position of markers 108. Cameras 102 may be collectively synchronized and calibrated, which may involve determining and recording of the relative timing and positions of the cameras 102 by host computer system 120 during a calibration routine, and/or by inter-camera synchronization and calibration without the use of a host computer. During calibration, one or more reference markers, such as a group of markers on a calibration wand 124, may be moved in view of the cameras 102 in order to create a set of marker position and timestamp data organized into a calibration data set from which relative positional offsets and viewing angle offsets of the cameras 102 may be derived. The capture volume 106 may be defined based on or as a result of the camera calibration procedure, wherein locations outside of the capture volume 106 are not visible to all or a sufficient number of the cameras 102 such that objects outside of the capture volume 106 may not be accurately trackable in 3D space by motion capture system 100. Further aspects and features of calibration procedures are well known, and many are described in U.S. Pat. No. 9,019,349.

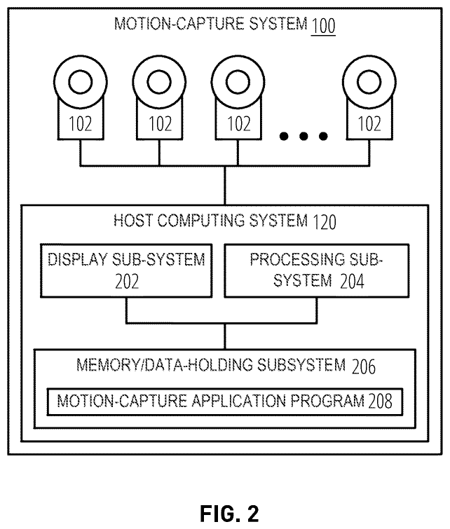

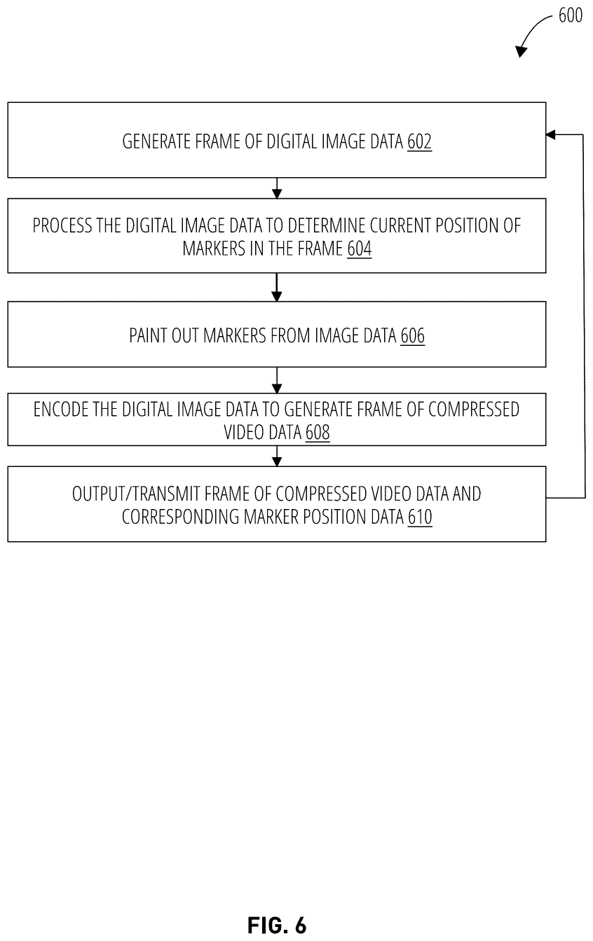

FIG. 2 is a schematic block diagram of motion capture system 100 and network connections between cameras 102 and host computer system 120. With reference to FIG. 2, cameras 102 may be directly connected to host computer system 120 as shown, via a suitable data connection such as USB, ethernet, wireless network (e.g., Wi-Fi 802.11), etc. In some embodiments, cameras 102 may be connected (e.g., via ethernet connection) to one or more network switches (not illustrated), which are then connected to host computer system 120 via further network connections. Host computer system 120 may include a display subsystem 202 and a data processing subsystem 204 in communication with a memory 206, which stores a motion-capture application program 208. The role of these elements of host computer system 120 will become apparent from the following description of the components and operation of camera 102, which proceeds with reference to FIGS. 6-8.

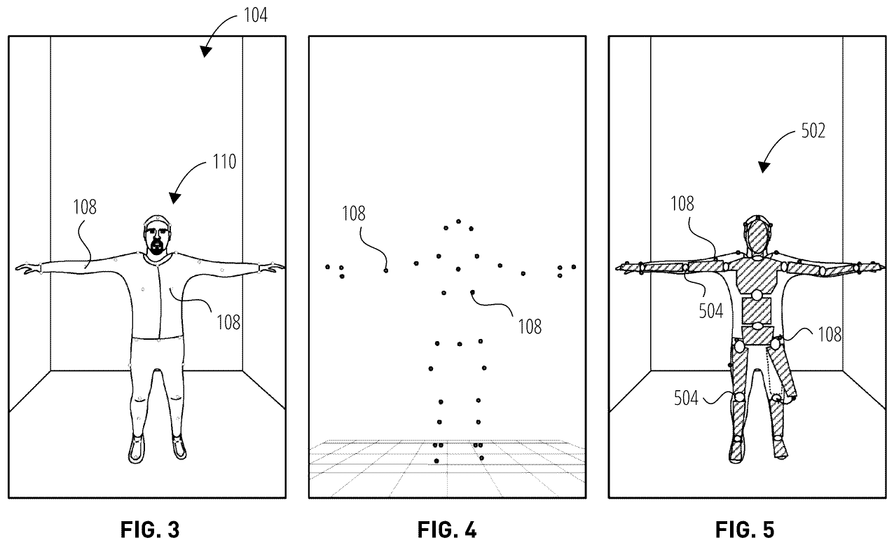

FIG. 3 shows a raw visual image of the scene 104 in the normal visual spectrum, captured by one of the cameras 102, including a subject 110 (person) with markers 108 attached, for example via a motion capture suit worn by the subject 110.

FIG. 4 illustrates marker-tracking data captured from the scene 104 of FIG. 3, showing the position of the markers 108 in the scene 104, but with the scene images omitted.

FIG. 5 illustrates an animated rendering of an object model 502 of the subject 110 of FIG. 3, including major skeletal joints 504, which has been generated by host computer system 120 from the marker-tracking data illustrated in FIG. 4. The marker-tracking data may be gathered from multiple cameras 102 to achieve accurate 3D positions of the markers 108. The object model 502 may represent or apply movement constraints of the joints 504. The locations of markers 108 may be illustrated relative to, or as part of, the object model 502.

The present inventors have observed recent efforts to develop artificial intelligence (AI) systems for markerless motion tracking that utilize video from one or more conventional video cameras. Markerless motion tracking systems of this sort operate as the name suggests, with the subjects and objects in the scene being presented without attached markers. Instead of marker position data, AI-based markerless systems determine the object model directly from image data utilizing software constructs such as neural networks and other machine learning systems. Such AI-based image processing techniques may derive the object model (e.g., locations of joints 504) largely from the edges and shape of objects appearing in the video. Such AI-based systems have not so far proven to be reliable or accurate, often generating artifacts and errors in the object model. One reason for the poor performance of existing AI-based markerless motion capture systems may be the lack of good training data. For example, most machine learning AI-based systems may be trained only on scene images and perhaps some user corrections or other supervisory feedback. Accordingly, the present inventors have identified an opportunity to gather and leverage large quantities of accurate high-fidelity training data including both scene data and synchronous marker position data. But known conventional camera systems are not capable of producing such high-fidelity synchronous data.

With reference to FIG. 6, a method 600 of generating high-fidelity synchronous image data and marker data according to the present disclosure includes the steps of providing one or more motion capture cameras, such as camera 102 having enhanced image capture and marker data capture capabilities, as is further described below with reference to FIGS. 7 & 8. In accordance with method 600, an image sensor 804 (FIG. 8) of camera 102 generates a series of frames of digital image data at a frame rate, representing a scene that is visible to the motion capture camera, wherein the scene includes moving subjects with a plurality of passive or active markers attached thereto. The image sensor 804 may be operated at a frame rate in the range of 10 frames per second (fps) (10 Hz) to approximately 500 fps (500 Hz), 1000 fps (1000 Hz), or higher, but more typically at a frame rate of 30 to 120 fps (20 to 120 Hz), 30 to 100 fps (30 to 100 Hz), or 30 to 60 fps (30 to 60 Hz) to produce relatively smooth video images. After the generation of a frame of digital image data via the image sensor 804 in step 602, the image data is processed onboard the camera 102 in steps 604 to 608 before being transmitted to a host computer system 120 or a data repository in step 610 for storage and later use, for example as training data for a machine learning system.

In step 604 of the method 600, each frame of at least some of the digital image data is processed via a marker tracking subsystem 806 (FIG. 8) of camera 102 to determine a current position of each of the markers 108 in the scene. Marker position data generated in this manner is a kind of meta-data regarding the raw image frame that can be used to annotate the image frame. In some examples, the entire series of frames of digital image data gathered by the image sensor 804 is processed in step 604 by the marker tracking subsystem 806 to generate marker position data for adjacent frames in the series. In other examples, only non-adjacent frames in the series are so-processed in step 604 as tracked frames. And in a further example, a series consisting of both adjacent frames and non-adjacent frames are processed by the marker tracking subsystem 806 as tracked frames in step 604. Because the marker tracking subsystem 806 operates onboard camera 102 on the raw image data, the accuracy of marker tracking is improved as compared with image data that has been compressed and transmitted off of camera 102, for example to a host computer system. Notably, bandwidth limitations make it impossible or infeasible to transmit the raw image data at the full frame rate of the image sensor 804 for off-camera processing, especially when using multiple cameras. Thus, transmission off of the camera at the frame rate typically requires the video image data to first be compressed on the camera prior to transmission. In contrast with a system that utilizes different cameras for capturing video and capturing marker tracking data, implementing the marker tracking subsystem 806 in the same camera 102 that gathers and transmits the video results in the marker data and video images being spatially and temporally aligned, at least as to the tracked frames processed by the marker tracking subsystem 806. This kind of “duplexed” capture of video and marker position data enables marker position data to be produced with higher fidelity using half the number of cameras.

At optional step 606, markers appearing in the image frame are optionally “painted out” of the image data by an optional marker removal subsystem 810 (FIG. 8) of the camera 102. The markers may be painted out of the image so that the video image data simulates a markerless scene for improved more realistic training data, while the marker position data (meta-data) provides “ground truth” feedback for machine learning.

In step 608, the digital image data (which may optionally be altered digital video image data, with the markers painted out) is encoded via an encoder 812 (FIG. 8) onboard camera 102 to generate compressed video data at the frame rate. A suitable encoder may compress the digital image data using an intra-frame-only compression scheme such as M-JPEG. In other embodiments, the digital image data may be encoded using an interframe video compression scheme such as H.264. Encoder 812 may comprise multiple encoding engines operating, e.g. in parallel, on different portions of a frame of image data or on different frames of a series of frames. Accordingly, encoder 812 may compress the digital image data (e.g., the altered digital image data) at the frame rate even though each of its multiple encoding engines may operate to compress the digital image data, or a portion thereof, at a rate that is much less than the frame rate. In some embodiments, wherein the markers are not painted out or are not painted out prior to compression, the compression of a frame of video image data in step 608 may occur simultaneously with processing the same frame of video image data in step 604 to determine the position of markers in the frame, for example in parallel processes on the same digital data processor 808 (FIG. 8) of the camera 102. In some embodiments, only a portion of the digital image data is compressed for transmission. For example, when extremely precise marker position data is needed but less precise video data is needed, marker position data may be gathered at a high frame rate (e.g., 1000 fps), but only some of the frames gathered at that high frame rate are encoded as compressed video—for example 100 fps comprising one of every 10 frames for which marker position data is gathered. In other embodiments, only a subset of the series of frames of digital image data gathered by the image sensor at the frame rate is processed to generate marker position data (i.e., the tracked frames are a subset of the series of frames of digital image data gathered), but the entire series of frames is encoded as compressed video—for example when less precision is needed, or for objects that are not moving or which move slowly.

In step 610, a communication device 814 (FIG. 8) of the camera 102 transmits the encoded compressed video data from the motion capture camera. Corresponding synchronous marker data for at least some of the frames encoded as compressed video data may also be transmitted. In some embodiments, the compressed video data and the synchronous marker data are transmitted at or about the frame rate. Alternatively, the synchronous marker data may be accumulated in memory 816 (such as DRAM memory onboard camera 102) for a series of frames or subset thereof, and the accumulated series of marker data sets may then be transmitted periodically or read by a host computer system periodically or on demand. The steps 602 to 610 may then be repeated for each successive frame captured by the image sensor. Accordingly, the marker tracking subsystem preferably generates a series of marker data sets at the frame rate, wherein each marker data set corresponds to what is visible in a corresponding one of the frames of the series of frames of images generated by the image sensor, including the current positions of the markers in each frame. In some embodiments, marker data sets are generated at the frame rate while only some of the frames are encoded as compressed video and transmitted, to reduce bandwidth while gathering high-speed marker data. In other embodiments, the entire series of video image data gathered at the frame rate is encoded and compressed, but only a subset of the frames is used to gather marker position data. Thus, in some embodiments, the marker position data may be gathered from adjacent frames, while in others it may be gathered from only non-adjacent frames, and in still others the marker position data may be gathered from a combination of adjacent and non-adjacent frames. In still other embodiments, a series of adjacent frames of digital image data may be encoded as compressed video data. And in yet other embodiments only a portion of a series of adjacent frames of digital image data is encoded—so that the compressed video consists essentially of non-adjacent frames, or consists essentially of a combination of adjacent and non-adjacent frames. In any event, at least some frames of the marker position data generated are synchronous with a corresponding frame of the video image data, since each frame of the marker position data and its corresponding video image frame (if transmitted) are generated from the same frame of image data gathered by the image sensor.

In some embodiments, training data generated by method 600 may involve gathering training data from a single camera 102. Alternatively, by utilizing the foregoing method with multiple synchronized cameras 102, different vantage points of a scene 104 and subject 110 can be obtained to generate training data for training a machine learning system to perform markerless motion capture using multi-camera setups, achieving much greater accuracy and fidelity than is possible with single-camera systems. In some embodiments, object models may be utilized in training machine learning systems. For example, the marker data may be mapped to corresponding object models before utilizing the mapped marker data (object model data) in training a machine learning system. For example, labeled marker data for a subject 110 that is a person may be mapped to an object model for a skeleton to derive the positions and orientations of major bones in the person's skeleton. Labeled marker data for a different subject 110, such as a rigid body or another type of object (other than a person), may be mapped to a different object model (different from a human skeleton). In some cases, multiple object models of the same or various types can correspond to multiple subjects and/or objects in a single video scene; and the scene video and ground truth data provided by the multiple object models may be used for training a machine learning system.

Similarly to the above-described training methods for machine learned systems that derive marker position data from markerless video, a machine learning system trained using object models may be configured to derive bone positions or other object model data from altered scene images in which the markers have been painted out, and its training improved by comparing its results to the bone positions or other object model data derived by motion capture system 100.

Motion capture system 100 and methods 600 may also be utilized to generate marker tracking data and video data (with or without painting out markers), that is sent to a machine learned system that has previously been trained, wherein the marker data and video data may both be utilized by the machine learned system for tracking. In a further example, cameras 102 of motion capture system 100 may perform some aspects of AI processing (pre-processing) onboard the camera 102 before sending the video data, output of the AI pre-processing, and optionally the marker position data, to a central host system or network for performing further AI processing.

FIG. 7 illustrates details of an exemplary motion capture camera 102 for use in practicing the inventive systems and methods according to the present disclosure. With reference to FIG. 7, camera 102 includes a lens 704 and a ring of Illumination sources 702 encircling the lens 704 on a forward portion 706 of camera 102. Electronics of camera 102, which are described below with reference to FIG. 8, may be housed primarily in a body 710 of camera 102 rearward of lens 704.

Turning now to FIG. 8, motion capture camera 102 includes an image sensor 804 which generates frames of digital image data from light focused on the image sensor 804 by a lens 704 of the camera 102. Image sensor 804 may include a CMOS image sensor with a global shutter or another type of sensor, and may be operated at a frame rate in the range of approximately 10 frames per second (fps) (10 Hz) to approximately 1000 fps (1000 Hz) or higher, but more typically at a frame rate of approximately 30 to approximately 120 fps (30 to 120 Hz) or 30 to 60 fps (30 to 60 Hz) to produce relatively smooth video images. In some embodiments, image sensor 804 may be operated in slave mode, with its shutter being triggered by a digital data processor 808 of camera 102 so as to allow digital data processor 808 to maintain shutter synchronization with other cameras 102. Camera 102 includes a marker tracking subsystem 806 which may be implemented in digital data processor 808 of camera 102 that is in communication with image sensor 804. Marker tracking subsystem 806 is configured to receive, read, or access digital image data generated by image sensor 804 and to process one or more frames of the digital image data to determine the position of markers in each particular image frame in the series of frames. Marker tracking data generated in this manner is synchronous with the frames of video image data so processed. Marker tracking subsystem 806 may be operable to generate a set of marker tracking data at or faster than the frame rate for images containing between 1 and 100 markers, or up to 1000 markers, or more preferably up to 10,000 markers or more.

Marker position data may be determined by marker tracking subsystem 806 of camera 120 using any of various image processing techniques. For example, determining the X-Y position of each of the markers 108 in an image frame may involve a first step of scanning rows of pixels to identify a region of interest (ROI) in the image meeting certain minimum criteria, such as a group of 2 or more adjacent pixels having a predetermined minimum brightness, etc. In some embodiments, marker tracking subsystem 806 may utilize marker position data previously determined for a preceding frame or preceding frames of video image data to assist in quickly finding the X-Y positions of the same markers in the current frame. For example, the X-Y marker position data for a marker 108 in a preceding frame may be held in memory 816 and utilized for a subsequent “current” frame of video image data to determine an ROI window within which to analyze for the same marker 108 in the current frame. As a further example, the marker position data for a particular marker 108 in a series of preceding frames may be utilized to approximate or represent a trajectory of the marker 108, which may be stored in memory 816 and utilized by the marker tracking subsystem 806 for a subsequent “current” frame to determine the ROI window to process for the current frame.

Camera 102 may optionally further include a marker removal subsystem 810 configured to alter each frame of digital image data to paint out or otherwise exclude the markers 108 from the image data, thereby creating an altered image, before compressing the altered image data via an encoder 812 and transmitting the compressed altered digital image data and marker position data from the camera via a communication device 814. The markers 108 may be conveniently and efficiently painted out of each frame of the raw digital image data via the ROI already stored in memory 816 during the optional step 604 of determining marker position and before re-assembling and encoding the altered (painted-out) digital image data, rather than from the full frame of digital image data or after encoding and compressing the digital image data. Painting out the markers from the video images before encoding the video images allows raw background data in the immediate surroundings of the markers 108 to be used for painting out, which is more accurate than using encoded data from the same region which can be corrupted during compression. Painting out the markers prior to encoding also allows the painted-out portions of the altered digital image data to be smoothed out and/or blurred by the encoding and compression process to thereby reduce the appearance of imperfections in the painted-out areas. In one embodiment, marker removal subsystem 810 may conveniently and efficiently operate on the pixel data in each ROI stored in memory 816, immediately after determination of the X-Y position of the marker 108 in the ROI. Painting out the markers in the ROI data may be more convenient and efficient from a data processing standpoint than painting out markers in the complete image frame. In some embodiments, the encoder 812 (or multiple encoding engines thereof) may operate in coordination with the marker removal subsystem 810 so as to begin encoding and compression only after marker removal has been performed and the painted-out regions re-assembled, at least as to the portion of the image frame being processed by the encoder 812.

Digital data processor 808 may comprise a CPU, a GPU, a field-programmable gate array (FPGA) or an application specific integrated circuit (ASIC) for example, and marker tracking subsystem 806 and/or marker removal subsystem 810 may be programmed into the digital data processor 808 and/or embodied in software stored in memory 816, or in another machine readable medium. In other embodiments, marker tracking subsystem 806 and marker removal subsystem 810 may be embodied in separate processors (such as separate ASICs), for example. In one embodiment, the image sensor 804 and the digital data processor 808 may be implemented in a single ASIC, which may optionally include memory 816 onboard.

Digital data processor 808 may be in communication with a memory 816 for storage of software programs and/or temporary storage of image data and/or marker tracking data. In some embodiments, encoder 812 may be included in or implemented as part of a codec. Encoder 812 may be implemented in a separate hardware encoder or hardware codec, for example, in communication with digital data processor 808 or may be implemented in a software program operating on digital data processor 808. Data communication device 814, such as a wireless data transceiver or Ethernet transceiver, is in communication with encoder 812.

The software instructions for implementing method 600 and other methods disclosed herein, or for implementing the marker tracking subsystem 806, optional marker removal subsystem 810, and optionally the encoder 812, may be stored in non-transitory computer readable medium, such as memory 206 or memory 816.

It will be obvious to those having skill in the art that many changes may be made to the details of the above-described embodiments without departing from the underlying principles of the invention. The scope of the present invention should, therefore, be determined only by the following claims.

The invention claimed is:

1. A motion capture system including at least one motion capture camera, each motion capture camera comprising:
an image sensor operating at a frame rate of between 10 and 1000 frames per second, which generates a series of frames of digital image data representing a scene that is visible to the motion capture camera;
a marker tracking subsystem, the marker tracking subsystem being configured to access the digital image data generated by the image sensor and to process at least a portion of the digital image data to determine, for each of at least some of the frames of the series of frames, a current position of each of a plurality of reflective or light-emitting markers attached to a moving subject in the scene, the marker tracking subsystem generating a series of marker data sets, each marker data set corresponding to one of a tracked series of frames of the series of frames and including the current positions of the markers in the scene;
an encoder configured to access the digital image data and to encode at least some of the series of frames as compressed video data, including at least some of the tracked series of frames processed by the marker tracking subsystem; and
a communication device configured to transmit the compressed video data and the series of marker data sets.

2. The motion capture system of claim 1, wherein the marker tracking subsystem generates the series of marker data sets at or about the frame rate of the image sensor.

3. The motion capture system of claim 1, wherein the communication device transmits the series of marker data sets at the frame rate.

4. The motion capture system of claim 1, wherein the marker tracking subsystem and the encoder are implemented in a digital data processor that is in communication with the image sensor and the communication device.

5. The motion capture system of claim 4, wherein the digital data processor includes a field-programmable gate array and/or an application specific integrated circuit.

6. The motion capture system of claim 1, further comprising a marker removal subsystem configured to alter each frame of the digital image data to paint out the markers in the scene before the series of frames of digital image data, so altered, are encoded by the encoder.

7. The motion capture system of claim 6, wherein both the marker tracking subsystem and the marker removal subsystem process a subset of the digital image data comprising a region of interest.

8. The motion capture system of claim 1, wherein the motion capture camera further comprises an illumination source.

9. The motion capture system of claim 8, wherein the illumination source includes an infrared illumination device.

10. The motion capture system of claim 1, further comprising a set of the motion capture cameras arranged around a capture volume for capturing different aspects of the scene, the set of motion capture cameras being interconnected via a local area network and collectively synchronized and calibrated.

11. The motion capture system of claim 10, further comprising a host computer system in communication with the motion capture cameras via the local area network, the host computer system configured to receive the compressed video data and the corresponding series of marker data sets from each of the motion capture cameras, and to store such compressed video data and series of marker data sets of the motion capture cameras so as to preserve a synchronization or a correspondence between each frame of the compressed video data and its corresponding marker data set.

12. The motion capture system of claim 1, wherein the tracked series of frames of digital image data consists essentially of one of: a series of adjacent frames, a series of non-adjacent frames, or a series of adjacent and non-adjacent frames.

13. The motion capture system of claim 1, wherein the tracked series of frames includes the entire series of frames.

14. A method of generating motion capture data and image data, the method comprising the steps of:
providing a motion capture camera including an image sensor operating at a frame rate of between 10 and 1000 frames per second, the motion capture camera configured to perform the steps of:
generating, via the image sensor, a series of frames of digital image data representing a scene that is visible to the motion capture camera;
processing at least a portion of the digital image data to determine, for each of at least some of the frames of the series of frames, a current position of each of a plurality of reflective or light-emitting markers attached to a moving object in the scene, the processing including generating a series of marker data sets, each marker data set corresponding to one of a tracked series of frames of the series of frames and including the current positions of the markers in the scene;
encoding at least some of the series of frames of digital image data, including at least some of the tracked series of frames, to generate compressed video data; and
transmitting the compressed video data and the series of marker data sets from the motion capture camera.

15. The method of claim 14, further comprising storing the compressed video data in conjunction with the corresponding series of marker data sets.

16. The method of claim 14, wherein the marker data sets are generated at or about the frame rate of the image sensor.

17. The method of claim 14, wherein the step of transmitting the compressed video data and the corresponding series of marker data sets includes transmitting the series of marker data sets at the frame rate.

18. The method of claim 14, further comprising:
prior to the step of encoding the series of frames of digital image data, for each frame of the digital image data, altering the digital image data to paint out the markers in the scene and thereby generate a frame of altered digital image data; and
wherein the step of encoding the series of frames of digital image data comprises encoding the frames of altered digital image data.

19. The method of claim 18, wherein the step of processing at least a portion of the digital image data to determine the current position of each of the markers includes identifying and processing a region of interest of the digital image data, and wherein the step of altering the digital image data to paint out the markers is performed on the region of interest.

20. The method of claim 18, wherein the steps of (a) processing the digital image data to generate the series of marker data sets, (b) altering the digital image data to paint out the markers, and (c) encoding the altered digital image data, are performed by a digital data processor of the motion capture camera.

21. The method of claim 14, further comprising receiving the compressed video data and the corresponding series of marker data sets from each of the motion capture cameras at a host computer system, and storing such compressed video data and series of marker data sets of the motion capture cameras so as to preserve a synchronization or a correspondence between each frame of the compressed video data and its corresponding marker data set.

22. The method of claim 21, further comprising interconnecting the set of motion capture cameras and the host computer system via a local area network, and collectively synchronizing and calibrating the set of motion capture cameras.

23. The method of claim 14, wherein the tracked series of frames of digital image data consists essentially of one of: a series of adjacent frames, a series of non-adjacent frames, or a series of adjacent and non-adjacent frames.

24. The method of claim 14, wherein the tracked series of frames includes the entire series of frames.

25. A non-transitory computer readable medium storing a software program for implementing the method of claim 14.

26. A method of training a machine learning system for markerless motion capture using the compressed video data and corresponding series of marker data sets generated by the method of claim 14.
